(19) United States
(12) Patent Application Publication
(10) Pub. No.: US 2009/0016799 A1
(43) Pub. Date: Jan. 15, 2009

(54) COSMETICS HOLDER

(76) Inventor: Christina Bellas, Farmington Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/166,435

(22) Filed: Jul. 2, 2008

Related U.S. Application Data
(60) Provisional application No. 60/949,079, filed on Jul. 11, 2007.

(51) Int. Cl. A45D 40/04; A45D 40/02; A45D 40/20; B28B 5/00

(52) U.S. Cl. 401/68; 401/87; 401/88; 264/297.2

(57) ABSTRACT

A cosmetic carrying cup is provided with a base member for supporting at least a first cosmetic product provided therein. An intermediate member for selective communication with the base member is provided. The intermediate member has at least one aperture to receive a removable cosmetic accessory. An upper member selective communicates with the intermediate member. The upper member supports at least a second cosmetic product provided therein. A method of manufacturing a cosmetic carrying cup is provided.

### BACKGROUND

1. Technical Field

The multiple embodiments of the present invention generally relate to a holder for various cosmetic products.

2. Background Art

With the hectic lives of people, time is limited. People are often rushing from one place to another with little time to spare. Even with such little time to spare, people typically desire to look and feel fresh throughout the entire day, no matter where they are. A large variety of cosmetics and cosmetic accessories may be employed to help people look and feel fresh.

### BRIEF DESCRIPTION OF THE DRAWINGS

FIG. 1 is a side elevation view of a cosmetic carrying cup;

FIG. 2 is a partially exploded perspective view of the cosmetic carrying cup of FIG. 1;

FIG. 3 is an exploded perspective view of the cosmetic carrying cup of FIG. 1;

FIG. 4 is a cross-sectional view of the cosmetic carrying cup of FIG. 1 taken along line 4-4;

FIG. 5 is a top plan view of a portion of the cosmetic carrying cup of FIG. 1;

FIG. 6 is a cross-sectional view of the cosmetic carrying cup of FIG. 5 taken along line 6-6 including an upper portion of the cosmetic carrying cup as illustrated in FIGS. 1-4; and

FIG. 7 a side elevation view of an upper body and a lower body of the cosmetic carrying cup of FIG. 1.

### DETAILED DESCRIPTION OF THE EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

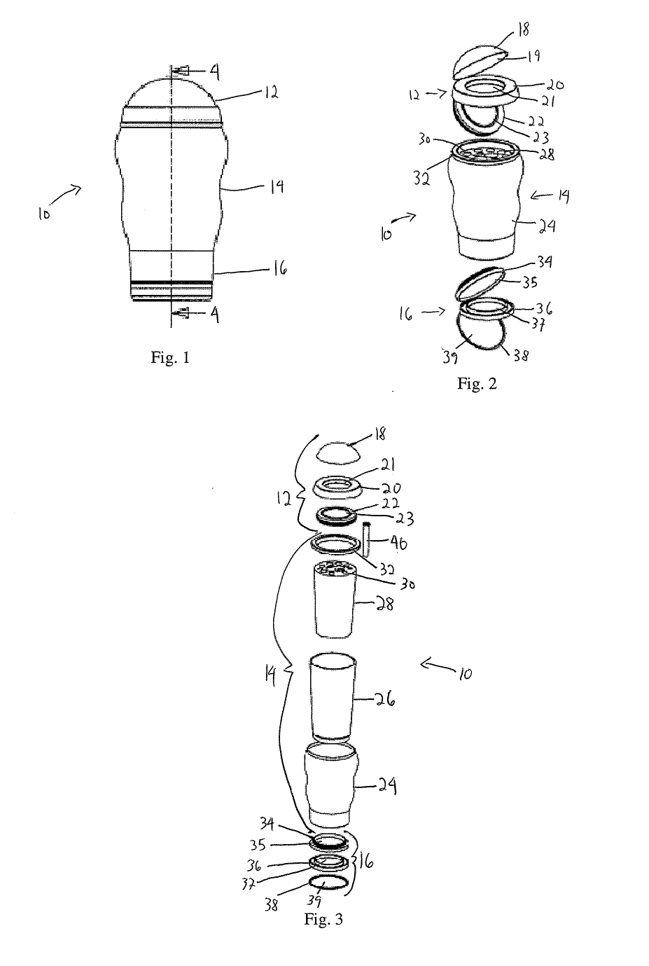

Referring to FIG. 1, a cosmetic carrying cup is illustrated and generally referenced by numeral 10. The cosmetic carrying cup 10 can hold multiple cosmetic products and multiple cosmetic accessories together in one convenient container 10. The cosmetic carrying cup 10 has an upper body 12, a main body 14 and a lower body 16. The cosmetic carrying cup 10 has a generally cup shape to facilitate easy transportation of the cosmetic carrying cup 10, and to easily fit in a hand of the user. In one embodiment, the cosmetic carrying cup 10 is sized to be received in a cup holder of a vehicle. In the depicted embodiment, the upper body 12 has an upper surface with a generally hemispherical shape. Of course any, suitable shape for an upper surface of the upper body 12 is contemplated within the scope of the present invention.

The cosmetic carrying cup 10 can provide an ecologically friendly option to carrying individual cosmetics because the cosmetic carry cup 10 can directly store multiple cosmetic products. Storing the multiple cosmetic products directly within the cosmetic carrying cup 10 eliminates a need for separate disposable containers for the multiple cosmetics and reduces waste produced by the separate disposable containers. Thus, the cosmetic carrying cup 10 an earth friendly alternative for consumers.

As illustrated in FIGS. 2-3, the upper body 12 is selectively attachable to the main body 14 at one end. The selective engagement between the upper body 12 and the main body 14 may be a threaded engagement. In another embodiment, the selective engagement between the upper body 12 and the main body 14 is achieved by fitting or snapping the upper body 12 into the main body 14 or fitting or snapping the main body 14 into the upper body 12. Of course, any suitable selective engagement between the upper body 12 and the main body 14 is contemplated within the scope of the present invention.

In the depicted embodiment, the main body 14 is selectively attachable to the lower body 16 at a second end. As illustrated, the second end of the main body 14 is generally opposite of the first end of the main body 14, which is selectively attached to the upper body 12. In the depicted embodiment, the main body 14 and the lower body 16 are selectively attachable by corresponding threading provided on the main body 14 and the lower body 16. In another embodiment, the main body 14 and the lower body 16 may be selectively fitted or snapped together. Any suitable selective engagement between the main body 14 and the lower body 16 is contemplated with the scope of the present invention.

As depicted, the upper body 12 has multiple components. The upper body 12 has a first mirror portion 18, a blush portion 20 and a bronzer portion 22. The first mirror portion 18 has a mirror 19 on one side. The first mirror portion 18 forms an upper surface opposite the mirror 19 on the one side of the first mirror portion 18. The blush portion 20 is provided between the first mirror portion 18 and the bronzer portion 22. The blush portion 20 has a blush 21 provided therein. Of course, any suitable blush cosmetic 21 or other cosmetic product that may be applied to a user may be provided in the blush portion 20. The bronzer portion 22 supports the first mirror portion 18 and the blush portion 20, and the bronzer portion 22 may be threaded for selective threaded engagement with the main body. The bronzer portion 22 has a bronzer 23 provided therein. Any suitable bronzer cosmetic 23 or other cosmetic product, which may be applied to a user, may be provided within the bronzer portion 22 of the upper body 12. In one embodiment, the mirror 19, the blush 21 and the bronzer 23 are refillable or replaceable in any suitable manner so that a second and new mirror, blush cosmetic and/or bronzer powder cosmetic may be supplied if needed. In another embodiment, the mirror 19, the blush 21 and the bronzer 23 are interchangeable.

In the illustrated embodiment, the first mirror portion 18 is selectively attachable to the blush portion 20. The bronzer portion 22 is selectively attachable to the blush portion 20 on an opposite side of the selective connection between the first mirror portion 18 and the blush portion 20. In another embodiment, the first mirror portion 18 is selectively attachable directly to the bronzer portion 22. Any suitable connection between the portions 18, 20, 22 of the upper body 12 is contemplated within the scope of the present invention. In one embodiment, the portions 18, 20, 22 have a hinged connection, which allows for access to any cosmetics and/or mirror provided therein.

The main body 14 serves as a receptacle for cosmetic accessories and can be connected to the upper body 12 and the lower body 16. The main body 14 has an outer portion 24, an inner portion 28 and a lip portion 32. In one embodiment, the outer portion 24, the inner portion 28 and the lip portion 32 are each formed separately and then connected together. In another embodiment, the outer portion 24, the inner portion 28 and the lip portion 32 are integrally formed.

The outer portion 24 of the main body 14 may be ergonomically shaped to be comfortable in a hand of a user. The outer portion 24 can be cup shaped and sized to be placed into a cup holder of an automobile. In one embodiment, the outer portion 24 is fabricated out of a stainless steel material to be visually appealing. In another embodiment, the outer portion 24 is fabricated out of a thermoplastic to withstand the demands of a user. Of course, the outer portion 24 may be made out of any suitable material.

In one embodiment, the inner portion 28 of the main body 14 fits into the outer portion 24 of the main body 14. The inner portion 28 may be formed out of a foam-type of material. Any suitable material for the inner portion 28 is contemplated within the scope of the present invention. In another embodiment, the inner portion 28 is formed into the outer portion 24. In yet another embodiment, the inner portion 28 is integrally formed with the outer portion 24.

As depicted in FIG. 3, the main body 14 includes an outer portion 24, an intermediate portion 26 and an inner portion 28. The intermediate portion 26 may be made out of thermoplastic, which may be injection molded. The outer portion 24 retains the intermediate portion 26. The intermediate portion 26 may be separately formed from the outer portion 24. The intermediate portion 26 retains the inner portion 28. In one embodiment, the inner portion 28 is removable from the intermediate portion 26 so that the inner portion 28 is replaceable with a new inner portion 28. In another embodiment, the inner portion 28 is integrally formed in the intermediate portion 26.

In FIGS. 2-3, the lower body 16 of the cosmetic holder 10 has a second mirror portion 34, a foundation portion 36 and a pressed powder portion 36. The second mirror portion 34 has a mirror 35 on one side. The second mirror portion 34 allows for selective connection to the main body 14 on a side opposite the mirror 35. The foundation portion 36 is provided between the second mirror portion 34 and the pressed powder portion 38. The foundation portion 36 has a foundation cosmetic 37 provided therein. Of course, any suitable foundation cosmetic or other cosmetic product, which may be applied to a user, may be provided in the foundation portion 36. The pressed powder portion 38 supports the second mirror portion 34 and the foundation portion 36 and may be adapted to be rested on an underlying support surface. The pressed powder portion 38 has a pressed powder cosmetic 39 provided therein. Any suitable pressed powder cosmetic 39 or other cosmetic product, which may be applied to a user, may be provided within the pressed powder portion 38 of the lower body 16. In one embodiment, the second mirror 35, the foundation 37 and the pressed powder 39 are refillable or replaceable so that a second and new mirror, foundation cosmetic and/or pressed powder cosmetic may be supplied if needed. In another embodiment, the mirror 35, the foundation 37 and the pressed powder 39 are interchangeable.

As depicted, the second mirror portion 34 is selectively attachable to the foundation portion 36. The foundation portion 36 is selectively attachable to the pressed powder portion 38 on an opposite side of the selective connection between the second mirror portion 34 and the foundation portion 36. In another embodiment, the second mirror portion 34 is selectively attachable directly to the pressed powder portion 38. Any suitable connection between the portions 34, 36, 38 of the lower body 16 is contemplated within the scope of the present invention. In one embodiment, the portions 34, 36, 38 have a hinged connection, which allows for access to any cosmetics and/or mirror provided therein.

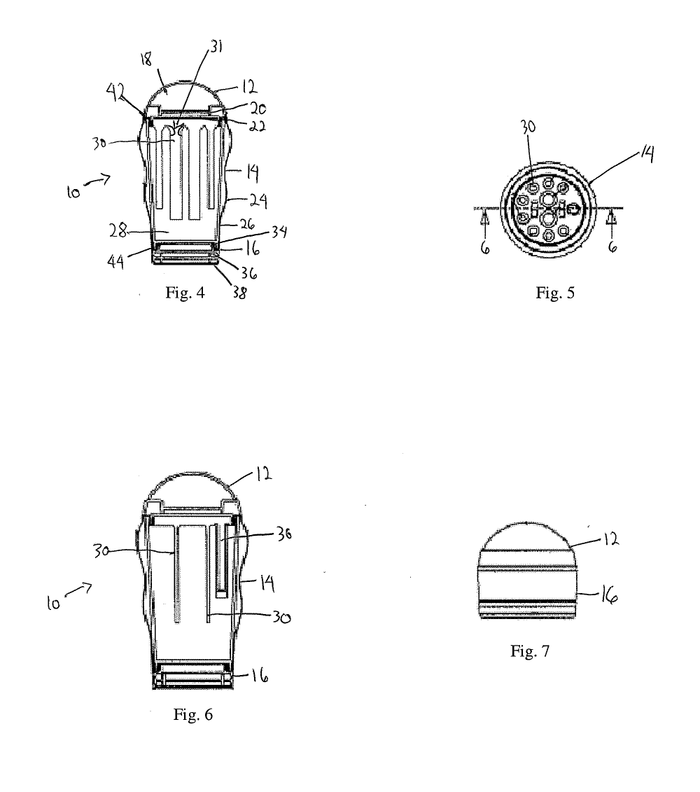

As illustrated in FIGS. 4-6, the inner portion 28 of the main body 14 has a plurality of receiving apertures 30 formed therein. The receiving apertures 30 are provided in the inner portion 28 to each receive and store a cosmetic accessory 40 illustrated in FIG. 3. Examples of a cosmetic accessory 40 include, but are not limited to, a facial brush, a concealer cosmetic, a cosmetic pencil, a tweezer, a nail file, a brush pick, a mascara brush, a cosmetic pencil sharpener, a hair brush, and a hair comb. The receiving apertures 30 may be any size and/or shape to reach receive a cosmetic accessory 40. Any suitable amount of receiving apertures 30 is contemplated within the scope of the present invention.

In one embodiment, at least one aperture 30 has a retainer 31. The retainer 31 holds a cosmetic accessory in the aperture 30 when the cosmetic accessory 40 is selectively placed therein. In another embodiment, the retainer is an elastomeric grommet 31 to reinforce the aperture 30 in addition to holding a cosmetic accessory. Of course, any suitable retainer 31 may be utilized within the scope of the present invention.

As illustrated in FIG. 4, the upper body 12 and the main body 14 may have a first seal 42 provided therebetween to provide a tight seal between the upper body 12 and the main body 14 when selectively connected together. The first seal 42 may be formed in one of the upper body 12 and the main body 14. A second sealer 44 may be provided between the main body 14 and the lower body 16 to selectively seal the main body 14 to the lower body 16. The second seal 16 may be formed in one of the main body 14 and the lower body 16. The seals 42, 44 may be made out of rubber or any suitable material. In one embodiment, the seals 42, 44 are o-rings.

Referring now to FIG. 7, the upper body 12 is selectively attachable to the lower body 16. The selective engagement between the upper body 12 and the lower body 16 allow a user to carry the upper body 12 and the lower body 16 as a compact cosmetic unit with a variety of cosmetic products provided therein. As illustrated, the upper body 12 and the lower body 16 may each have threading formed respectively thereon so that the upper body 12 may have a threaded engagement with the lower body 16.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A cosmetic carrying cup comprising:
a base member supporting at least a first cosmetic product provided therein;
an intermediate member for selective communication with the base member, the intermediate member provided with at least one aperture to receive a removable cosmetic accessory; and
an upper member for selective communication with the intermediate member, the upper member supporting at least a second cosmetic product provided therein.

2. The cosmetic carrying cup of claim 1 wherein the base member and the intermediate member are respectively threaded to facilitate the selective communication therebetween.

3. The cosmetic carrying cup of claim 1 wherein the intermediate member and the upper member are respectively threaded to facilitate the selective communication therebetween.

4. The cosmetic carrying cup of claim 1 further comprising a first ring provided between the base member and the intermediate member to facilitate sealing the base member and the intermediate member together.

5. The cosmetic carrying cup of claim 1 further comprising a second ring provided between the intermediate member and the upper member to facilitate sealing the intermediate member and the upper member together.

6. The cosmetic carrying cup of claim 1 wherein the base member and at least a portion of the intermediate member are sized to be received in an vehicle cup holder.

7. The cosmetic carrying cup of claim 1 wherein the at least one aperture formed in the holder has a grommet provided therein to facilitate securing the cosmetic accessory in the at least one aperture.

8. The cosmetic carrying cup of claim 1 wherein the base member further comprises:
a first base member element provided for selective communication with the intermediate member;
a second base member element provided for selective communication with the first upper member element; and
a third base member element provided for selective communication with the second upper member element;
wherein at least one of the first, second third base member elements is capable of supporting the at least a first cosmetic product.

9. The cosmetic carrying cup of claim 8 wherein the first base member element has a hinged connection with the second base member element.

10. The cosmetic carrying cup of claim 8 wherein the second base member element has a hinged connection with the third base member element.

11. The cosmetic carrying cup of claim 8 wherein one of the first, second and third base member elements has a mirror provided therein.

12. The cosmetic carrying cup of claim 11 wherein another of the first, second and third base member elements has the at least a first cosmetic product provided therein.

13. The cosmetic carrying cup of claim 1 wherein the upper member further comprises:
a first upper member element provided for selective communication with the intermediate member;
a second upper member element provided for selective communication with the first upper member element; and
a third upper member element provided for selective communication with the second upper member element, the third upper member element having a generally hemispherical outer surface;
wherein at least one of the first, second third upper member elements has the at least a second cosmetic product provided therein.

14. The cosmetic carrying cup of claim 13 wherein one of the first, second and third upper member elements has a mirror provided therein.

15. The cosmetic carrying cup of claim 14 wherein another of the first, second and third upper member elements has the at least a first cosmetic product provided therein.

16. The cosmetic carrying cup of claim 1 wherein the intermediate member further comprises:
an outer cup portion generally sized for a hand of a user; and
a holder provided within the outer cup portion, the holder having the at least one aperture provided therein.

17. The cosmetic carrying cup of claim 16 wherein the intermediate member further comprises:
an inner cup portion sized to be received within the outer cup portion for supporting the holder.

18. The cosmetic carrying cup of claim 1 wherein the base member is adapted to be rested on an underlying support surface.

19. A cosmetic carrying system comprising:
a base member adapted to be rested on an underlying support surface, the base member adapted to receive at least a first cosmetic product provided therein;
an intermediate member for selective communication with the base member, the intermediate member provided with at least one aperture, the at least one aperture adapted to receive a removable cosmetic accessory therein; and
an upper member for selective communication with the intermediate member, the upper member adapted to receive at least a second cosmetic product therein.

20. A method of manufacturing a cosmetic carrying cup comprising:
injecting molding a base member and an upper member, the base member and the upper member each adapted to hold a cosmetic product therein;
forming a body member which selectively communicates with the base member at a first end of the body member and the upper member at a second end of the body member; and
providing at least one aperture in the body member sized to receive a cosmetic accessory.
